(19) United States
(12) Patent Application Publication
(10) Pub. No.: US 2020/0218809 A1
(43) Pub. Date: Jul. 9, 2020

(54) Logical and Physical Security Device

(71) Applicant: U.S. GOVERNMENT AS REPRESENTED BY THE SECRETARY OF THE ARMY, Washington, DC (US)

(72) Inventor: Robert H. Lam, Warren, MI (US)

(21) Appl. No.: 16/243,159

(22) Filed: Jan. 9, 2019

(51) Int. Cl. G06F 21/56; G06F 21/55; G06F 21/85; G06F 13/42

(52) U.S. Cl. CPC G06F 21/567; G06F 21/566; G06F 21/554; G06F 2213/0042; G06F 13/4282; G06F 2221/034; G06F 21/85

(57) ABSTRACT

One example is security device for protecting a remote host device. The security device includes an output connector, an input connector, a data cable with a first end and a second end, a memory buffer and a malware detection logic. The first end of the data cable is connected to the output connector and the second end of the data cable is connected to the remote host device. The remote host device and the security device are physically separated by the data cable. The input connector receives digital data from the peripheral device and the memory buffer stores the digital data. The malware detection logic searches the digital data stored in the memory buffer for malware residing in the digital data. The malware detection logic removes digital data in the memory buffer that is associated with malware.

### GOVERNMENT INTEREST

The inventions described herein may be made, used, or licensed by or for the U.S. Government for U.S. Government purposes without payment of royalties. The U.S. Government has rights in the invention.

### TECHNICAL FIELD

A security device relates generally to computer security. A security device is external from the host computer and detects corrupted data or undesirable signals before they reach the host computer. One security device is configured to operate with a universal serial bus (USB) connector.

### BACKGROUND

Conventional approaches to computer security include the detection of viruses (a type of malware) when they are downloaded into a computer and/or received in a computer through a mail attachment or another type of attachment. In general, a common type of computer virus is malicious software that, when executed, replicates itself by modifying other computer programs and inserting its own code. When this replication succeeds, the affected areas are then said to be “infected” with a computer virus.

Virus writers may use social engineering deceptions and exploit knowledge of security vulnerabilities to initially infect systems and to spread the virus. The vast majority of viruses target systems running Microsoft Windows, employing a variety of mechanisms to infect new hosts, and often using complex anti-detection/stealth strategies to evade antivirus software. Motives for creating viruses can include seeking profit (e.g., with ransom-ware), desire to send a political message, personal amusement, to demonstrate that a vulnerability exists in software, for sabotage and denial of service, because there is a desire to explore cybersecurity issues, a desire to implement a form of artificial life or evolutionary algorithms, and the like.

Computer viruses currently cause billions of dollars' worth of economic damage each year, due to causing system failure, wasting computer resources, corrupting data, increasing maintenance costs, etc. In response, free, open-source antivirus tools have been developed, and an industry of antivirus software has cropped up, selling or freely distributing virus protection to users of various operating systems. As of 2005, even though no currently existing antivirus software was able to uncover all computer viruses (especially new ones), computer security researchers are actively searching for new ways to enable antivirus solutions to more effectively detect emerging viruses, before they have already become widely distributed.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

One example is a security device for providing security to a host device (e.g., computer). The security device includes an output connector, an input connector, a data cable, a memory buffer and malware detection logic. The data cable has a first end and a second end. The first end of the data cable may be connected to the output connector and the second end of the data cable may be connected to a remote host device. The remote host device and the security device are physically separated by the data cable. The input connector is for receiving digital data from a peripheral device. The memory buffer stores the digital data in the memory buffer that was received from a peripheral device connected to the input connector. The malware detection logic searches the digital data stored in the memory buffer for malware residing in the digital data and may remove digital data in the memory buffer that is associated with malware residing in the digital data.

Another embodiment is a security system that provides logic protection and physical protection to a remote host device (e.g. remote host computer). The USB security device includes a USB cable, a first connector, a second connector, a buffer, a malware detection logic and isolation circuits. The first USB connector connects to a USB device. The USB cable connects between the second USB connector and the remote host device. The buffer stores device data received from the USB device and the malware detection logic determines data containing malware by searching device data in the buffer for malware. When malware is detected, the malware detection logic prevents device data associated with the detected malware from reaching the remote host device. The isolation circuit isolates the USB device from the remote host device when an unwanted electrical characteristic is detected on the USB cable.

Another configuration is a method of physically and logically isolating a host device from a USB device. The method begins by connecting a security device between the USB device and the host device. A USB cable connects the security device to the host device. Device data received from the USB device is stored into a memory buffer within the security device. The method detects if data containing malware exists in the device data by searching device data for malware. When malware is detected, device data associated with the detected malware is prevented from reaching the remote host device. The USB device is isolated form the remote host device when an unwanted electrical characteristic is detected on the USB cable.

The following description and the annexed drawings set forth in detail certain illustrative aspects of the subject matter. However, these aspects are indicative of some of the numerous ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an embodiment of a malware detection system for logically protecting a remote host computer from malware threats.

FIG. 2 illustrates a portion of a memory illustrating how malware may be detected within memory by malware detection logic.

FIG. 3 illustrates an embodiment of a malware detection system for logically and physically protecting a remote host computer from malware and electrical threats.

FIG. 4 illustrates another embodiment of a malware detection system for logically protecting a remote host from malware threats and physically protecting the remote host from electrical/physical threats.

FIG. 5 illustrates another embodiment of a malware detection system for logically and physically protecting a remote host computer from malware and physical/electrical threats.

FIG. 6 illustrates a flow of a method of physically and logically isolating a host device from a USB device.

FIG. 7 illustrates an example view of an embodiment of a computer system for detecting malware before it reaches a host computer.

Items with the same reference numbers in different drawings are similar.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

Portable electronic devices are often connected to work computers. Whenever an electronic device such as a universal serial bus (USB) device is connected to a computer there is a risk that the USB device may cause harm (whether intentional or unintentional) to the computer. USB devices have become so prevalent that the need to use them has become nearly unavoidable. However, some organizations will not permit users to connect a USB memory “stick” or “thumb drive” directly into a computer owned by the organization in an effort to minimalize/eliminate the possibility of a USB peripheral device infecting the computer with malware. In some configurations, the peripheral device may be a hand-held device such as a thumb drive/memory stick, smart phone, or other devices as understood by those of ordinary skill in the art. A USB security device is proposed to provide a level of protection to protect computer systems from portable devices, USB devices, and the like that may be connected to the computer system.

The security device is a portable electronic device which is intended to connect in-line between a host and a device that may be a portable electronic device. The intent is to use that security device to provide a security point between the electronic device and the host where security actions may be taken to safeguard the host. Security actions may include complete disconnection of the device from the electronic device, filtering of packets, sanitization of data, and the like. The security device may have programmable behavior (i.e. firmware or software) so that it may be updated or customized as desired.

In one example configuration, the proposed security device is a portable USB type of electronic device. The USB security device may be intended to increase the security of individual computers assigned to employees in a work type environment when the need to use portable USB devices arises. The USB security device connects to a computer with a USB cable (or any desired cable) connected between the USB security device and the computer. The portable USB device that is to be used with that computer is connected to the USB security device with a USB connector so that the USB security device is physically between the computer and the portable USB device.

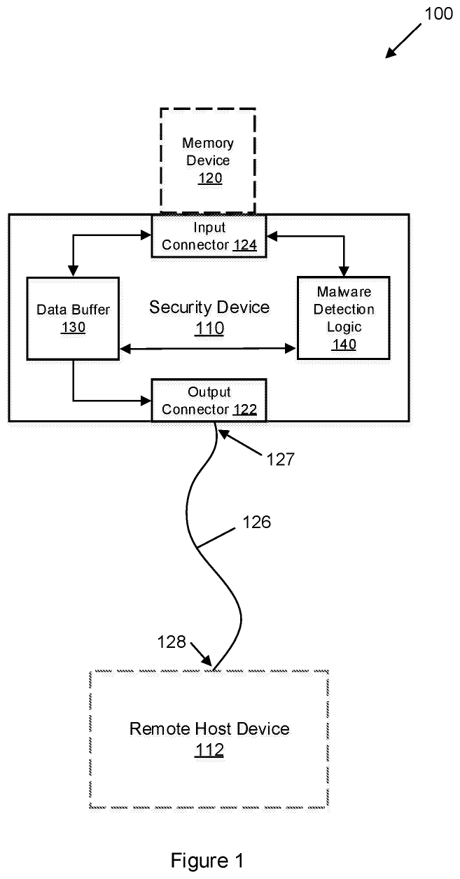

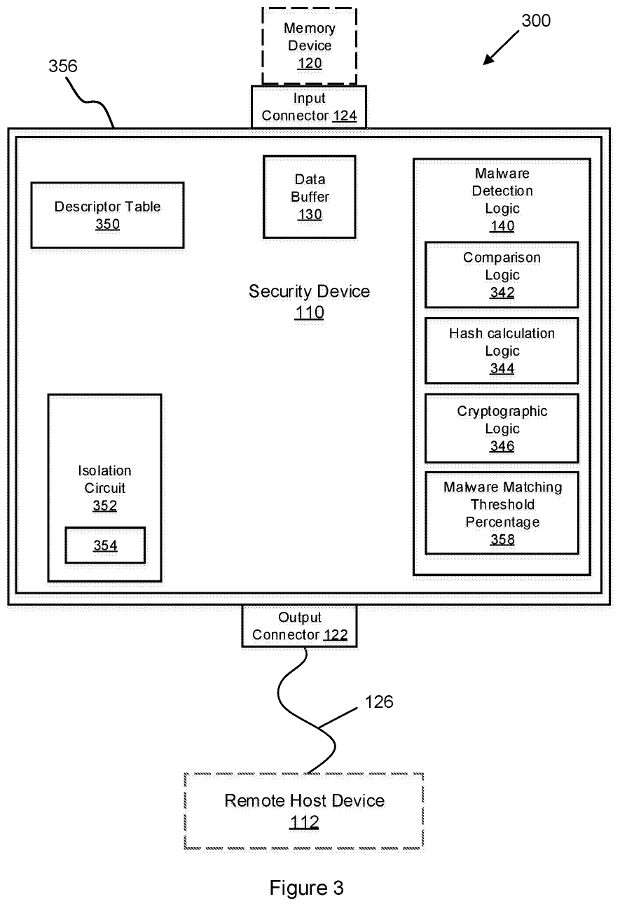

FIG. 1 illustrates an example of a security system 100 preventing malware from reaching a remote computer using the security device 110. This example figure illustrates the security device 110 connected between a peripheral device 120 and a remote host device 112 that may be a host computer. Of course, the peripheral device 120 may be any desired electronic device and the remote host device 112 may typically be any computer device. The peripheral device 120 is connected to the security device 110 with an input connector 124 on the security device 110 and the remote host device 112 is connected to the security device 110 with a data cable 126 that may have USB connecters or other types of connectors. The data cable 126 has a first end 127 that may be connected to an output port 122 on the security device 110 and a second end 128 that may be connected to the remote host device 112. The security device 110 of example FIG. 1 has a data buffer 130 for receiving data from the input connector 124 and a malware detection logic 140 that searches for malware within data in the data buffer 130 or for malware within data transferred from the data buffer 130 to the malware detection logic 140. The security device 110 further may be enclosed in a housing 356 (FIG. 3) with the malware detection logic 140 and the data buffer 130 contained within the housing 356 with the data cable 126 passing from the housing 356 to the remote host device 112.

“Processor” and “Logic”, as used herein, includes but is not limited to hardware, firmware, software and/or combinations of each to perform a function(s) or an action(s), and/or to cause a function or action from another logic, method, and/or system. For example, based on a desired application or needs, logic and/or processor may include a software-controlled microprocessor, discrete logic, an application specific integrated circuit (ASIC), a programmed logic device, a peripheral device containing instructions or the like. Logic and/or processor may include one or more gates, combinations of gates, or other circuit components. Logic and/or a processor may also be fully embodied as software. Where multiple logics and/or processors are described, it may be possible to incorporate the multiple logics and/or processors into one physical logic (or processors). Similarly, where a single logic and/or processor is described, it may be possible to distribute that single logic and/or processor between multiple physical logics and/or processors.

The protection provided by the security device 110 (in some configurations a USB security device) may be divided into two main categories: (1) physical protection and (2) logical protection. A primary physical protection for the USB security device may be electrical isolation. Electrical isolation addresses scenarios where the suspect USB device may experience inadvertently or intentionally overloaded electrical connections potentially causing physical damage to the host computer. The suspect peripheral device 120 such as USB peripheral device may connect to the remote host computer 112 through the USB security device 110 and the USB security device may provide an isolation point where electrical inputs on the remote host computer 112 can be isolated from the suspect USB peripheral device (peripheral device 120).

In one example, the data lines of the data cable 126 are protected using isolation circuit(s) 352 of the security system 300 illustrated in FIG. 3. The isolation circuit(s) 352 may create opto-isolation and/or isolate the data cable 126 using resettable circuit breaker type components to protect the remote host device 112 from power surges on the electrical connections of data cable 126. The isolation circuit 352 may isolate the remote host device 112 from electrical current when a voltage on the data cable 126 exceeds a threshold value and/or when a current on the data cable 126 exceeds a threshold value. Optical isolation circuits 354 (FIG. 3) may be based on fiber optic technology and used to optically isolate the security device 110 from the remote host device 112. The data cable 126 may be any suitable length and in some embodiments may be at least three feet long.

Logical protection of computer systems is the protection of the remote host device's resident software and data. In some configurations, the security device 110 may be a USB security device. As discussed below, the security device 110 may have resident computing capability that may be used to execute functions providing logical protection. In at least one configuration, there are two functions intended to provide logical protection to the host computer: (1) a trusted/non-trusted device approach and (2) an anti-virus detection approach. Both of these approaches are intended to recognize when communications from a suspect memory device 120 (USB device) should not be permitted to reach the remote host computer 112. Each of these approaches will be described in further detail below.

In some configurations, the security device 110 may run anti-malware (e.g., antivirus) software within the security device 110 or the malware detection logic 140, itself. In general, anti-malware software is designed to detect, prevent and take action to disarm or remove malicious software from computers such as viruses, worms, Trojan horses, inter alia. It may also prevent more sophisticated malware by finding and removing unwanted spyware, adware, and the like.

As used herein, the term “virus” is used to mean a computer virus but is also a type of “malware”. “Malware” is a broader term than “virus” because “malware” further encompasses computer “viruses” and many other forms of malicious software, such as computer “worms”, ransom-ware, spyware, adware, Trojan horses, keyloggers, rootkits, bootkits, malicious browser helper objects (BHOs) and other malicious software. The majority of active malware threats are actually Trojan horse programs or computer worms rather than computer viruses. Viruses/malware often perform some type of harmful activity on infected host computers, such as acquisition of hard disk space or central processing unit (CPU) time, accessing private information (e.g., credit card numbers), corrupting data, displaying political or humorous messages on the user's screen, spamming their e-mail contacts, logging their keystrokes, or even rendering the computer useless. However, not all viruses carry a destructive “payload” and attempt to hide themselves—the defining characteristic of viruses is that they are self-replicating computer programs which modify other software without user consent.

After malware has already reached a computer's memory and is residing inside a computer, traditional anti-malware software begins by checking programs residing in a computer program and compares them to known types of malware. The security device 110 of FIG. 1 does at least some of this checking in the security device 110 preventing the malware from reaching the computer system (remote host device 112).

The security device 110 may detect computer viruses/malware in individual files stored in the security device 110 that are desired to be uploaded to the host. In other configurations, malware may be removed from sequential blocks of data traffic that are stored in the security device desiring to reach the host and/or from other types data buffered by the security device. This buffered data can then be checked by the security device 110 for malware.

Several traditional techniques are now briefly reviewed that may be used to utilized to detect malware. For example, upon the malware already reaching a computer, traditional anti-malware will scan files residing inside the computer and may also scan the computer for behaviors that may signal the presence of a new, unknown malware. Typically, antivirus software uses three scanning detection processes: specific detection, generic detection, and heuristic detection. Specific detection works by looking for known malware by a specific set of characteristics. Generic Detection is a process of looking for malware that are variants of known “families,” or malware related by a common codebase. Heuristic detection involves scanning for previously unknown viruses by looking for known suspicious behavior or file structures.

In general, viruses/malware contains some common characteristics. For example, a viable computer virus/malware may contain a “search routine”, which locates new files or new disks which are worthwhile targets for infection. Secondly, computer viruses may contain a “copy routine” to copy itself into the program. Both the search routine and the copy routine would each have their own routine code (data) sequences. Thus, an anti-malware search routine within the malware detection logic 140 should have the ability to locate this type of malware because the search routines and copy routines in this type of malware are generally coded as sequential loops or in other common/known formats. Based on this, the anti-malware routine simply needs to search for these known virus/code formats to find the malware and begin the processing removing the malware or accounting for the malware in other ways.

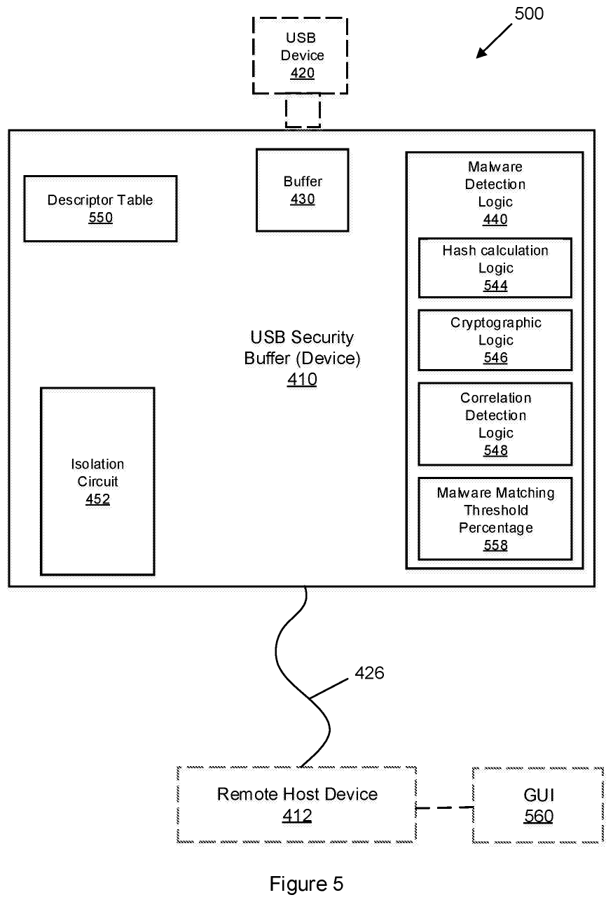

Most modern antivirus programs try to find virus-patterns inside ordinary programs by scanning them for so-called virus signatures. Unfortunately, the term “signature” is misleading, in that viruses do not possess unique signatures in the way that human beings do. Such a virus “signature” is merely a sequence of bytes that an antivirus program looks for because it is known to be part of the virus. A better term may be “search strings”. Different antivirus programs will employ different search strings, and indeed different search methods, when identifying viruses. If a virus scanner finds such a pattern in a file, it may perform other checks to make sure that it has found the virus, and not merely a coincidental sequence in an innocent file, before it notifies the user that the file is infected. In some configurations, the security device 110 may then prompt the user through GUI 560 (FIG. 5) to delete, or (in some cases) “clean” or “heal” the infected file.

Other configurations include a comparison logic 342 (FIG. 3) to search the digital data stored in the memory buffer 130 with known malware data. The malware detection logic 140 detects malware based, at least in part, on the search performed by the comparison logic 342. In some configurations, the comparison logic 342 compares data in the data memory 130 against malware signatures. These comparisons may be performed using hexadecimal/byte data or in another desired format (after conversion).

Some viruses employ techniques that make detection by means of searching for known sequences of data difficult but probably not impossible. These viruses modify their code on each infection. That is, each infected file contains a different variant of the virus. In these cases, the malware detection logic 140 may search as discussed above and additionally keep track of how many bytes of substrings of a virus are found. For example, if enough substrings are found within a section of memory with relatively close addresses, then a virus may be determined to have been detected by the malware detection logic 140 even if the entire string of a known virus was not found. In one configuration, the malware detection logic 140 includes a malware matching threshold percentage 358. This may be a user specified value of how many data values need to match to be confident malware has been detected. When the malware detection logic 140 determines more than the malware matching threshold percentage 358 of device data matches a known malware signature within a defined range of memory of the memory buffer, the malware detection logic 140 determines that malware is detected.

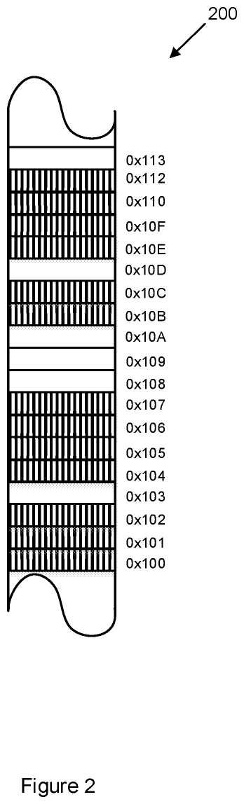

For a more detailed example, FIG. 2 illustrates a section of memory 200 that may contain a virus. The memory portion 200 includes hexadecimal addresses 0x100 through 0x113 that may contain malware or portions of malware. In this example, Address locations 0x100-0x102, 0x104-0x107, 0x10B, 0x10C and 0x10E-0x112 contain portions of malware. That is, 13 of 18 consecutive memory locations, or 72.2%, contain or have been searched and matched for data associated with malware. For example, if 75% of consecutive memory locations of at least 16 memory address are determined to contain known portions of a known malware, then malware is determined to have been detected by the malware detection logic 140 (FIG. 1). In the example of FIG. 2, the malware detection logic 140 would not consider memory locations 0x100 through 0x112 to contain malware because 72.2 percent of those locations contain portions of a known malware which is below a malware matching threshold percentage of 75%. However, if the malware matching threshold percentage were 78% then the malware detection logic 140 would consider memory locations 0x100 through 0x112 to contain malware.

In alternative embodiments, the security device 110 may make the decision on whether to allow communications from the suspect USB device to reach the host computer 112 based on a device descriptor reported by the memory device 120 connected to the security device 110. For example, many USB devices have an identification (ID) tag or descriptor that may be read out of the USB device which may identify this USB device as being a trusted type of device and/or from a trusted source. Knowing this information, the security device 110 may read the device descriptor from the USB device. This device descriptor is then compared against a descriptor table 350 (FIG. 3) of prior known trusted devices and/or untrusted devices. For example, the security device 110 may include a descriptor table with a list of device descriptors indicating if a device is trusted device or non-trusted device. The security device 110 allows the digital data in the memory buffer 130 to access the remote host device 112 based, at least in part, on the device descriptors in the descriptor table 350.

The USB security device may make the decision on whether to allow communications from the suspect USB device to reach the host computer based on the device descriptor reported by the suspect device and whether it was non-trusted device and/or trusted device. For example, data from a device may be permitted by the security device 110 to reach the remote host device 112 if the peripheral device (USB device) is a trusted device, or if the USB device is not a non-trusted device. For example, trusted devices and their data may be transferred to the remote host device, while non-trusted devices and their data may be prevented from reaching the remote host.

FIG. 3 illustrates an example configuration of a security system 300 that uses a security device 110 to logically and physically protect a remote host device 112. Similar to FIG. 1, the security system includes a peripheral device 120, a security device 110 and a remote host device 112. The security device 110 includes a data buffer 130, a malware detection logic 140, a descriptor table 350, and an isolation circuit. The malware detection logic 140 has a comparison logic 342, a hash calculation logic 344, a cryptographic logic 346 and a malware matching threshold percentage 358. Items with similar reference numbers to FIG. 1 operate similarly to those corresponding items in FIG. 1.

The security device 110 of FIG. 3 may have other useful features and components. For example, each time a peripheral device 120 such as a USB device is connected for use with the USB security device, the USB security device should begin copying the data that the suspect peripheral device 120 is attempting to transfer to the host computer into storage buffer 130 resident on the security device 110. During operation, the security device 110 continuously scans the data that has been accumulated in the data buffer 130 to search for signatures that match virus signatures, as discussed above. In some embodiments, if a signature is encountered that matches a known virus signature, communications from the suspect USB device to the host computer should be blocked. In some configurations, the security device may have a cryptographic logic 345 and a hash calculation logic 344 that may be used to decrypt and authenticate encrypted data respective so that the malware detection logic may then search for malware on the un-encrypted plaintext as describe further below with reference to FIG. 5.

The security device 110 may also have a way of updating its resident software/firmware so that information such as which device descriptors of peripheral device 120 that should be blocked or virus signatures may be updated over time. The ability to update the resident software/firmware that may reside in the malware detection logic 140 or other places within the security device 110 may even allow new functionality to be introduced onto the USB security device at later times.

The USB security device's (security device's 110) ability to store data that is sent from suspect USB devices (peripheral device 120) also provides the opportunity to make this data available for further analysis. The USB security device should capture a new set of data each time a new connection from a suspect USB device is made. It is recommended that as much storage memory as economically reasonable should be integrated into the data buffer 130 of the USB security device. Based on how much memory is available, it is possible that the USB security device may be designed to retain multiple sessions of communications data. In such cases, it is recommended that as memory capacity becomes depleted, earlier data captures may be overridden in chronological order. The USB security device may in some alternative configurations provide a technique for retrieving the stored data for later analysis.

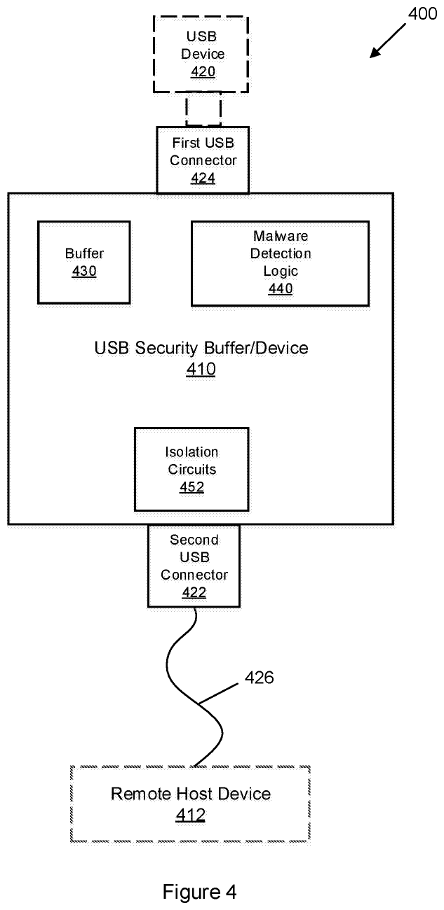

FIG. 4 illustrates another embodiment of a security system 400 that is a USB security device 410 to both logically and physically protect a remote host device 412. The USB security buffer 410 (e.g., security device) of FIG. 4 contains a buffer 430 and a malware detection logic 440 that may be similar to the malware detection logic 140 of FIG. 1. The buffer 430 may be any suitable memory of any suitable size as understood by those of ordinary skill in the art. A USB device 420 may be connected to first USB connector 424 of the security buffer 410. A USB cable 426 connects a second USB connector 422 of the USB security buffer 410 (or security device) to a remote host device 412. The USB security device 110 also contains buffer isolation circuits 452 that isolate the USB device 420 and the security buffer 410 from the remote host device 412 when an unwanted electrical characteristic such as high voltage/and or current is detected in the USB security device 110 or on the USB cable 426.

Similar to the security device 110 of FIGS. 1-3, the buffer 430 of FIG. 4 stores device data received from the USB device 420. The malware detection logic 440 determines data containing malware by searching device data in the buffer 430 for malware similar to the techniques discussed above. When malware is detected, the malware detection logic 440 may prevent device data associated with the detected malware from reaching the remote host device 412. In some configurations, the malware detection logic 430 includes a malware matching threshold percentage 558 as illustrated in the security system 500 of FIG. 5. When more than the malware matching threshold percentage 558 (FIG. 5) of device data matches a known malware signature within a defined range of memory of the memory buffer, the malware detection logic 440 determines that malware is detected. In some configurations, correlation detection logic 548 (FIG. 5) correlates device data in the buffer 440 to known malware signatures. When malware is detected by correlation, the malware detection logic 430 may prevent device data associated with the detected malware from reaching the remote host device 412.

The USB security device 410 essentially acts as a physical “firewall” between the remote host device 412 (USB host) and a USB device 420 that may be a portable electronic USB device. The intent is to provide a security point between the USB host and the USB device 420 where security actions may be taken to safeguard the host. Security actions may include: complete disconnection of the USB device 410 from the USB host, filtering of packets, sanitization of data, etc. The USB security device is intended to have programmable behavior (i.e. firmware or software) so that it may be updated or customized, as need be.

In order to avoid detection by users, some viruses employ different kinds of deception that may still allow this type of malware to be detected if it the file containing it is loaded into the buffer 430 from the USB device 420. For example, some viruses act as stealth viruses by infecting files without increasing the files size or damaging the files. They accomplish this by overwriting unused areas of executable files. These are called cavity viruses. For example, the Chernobyl Virus (ClH) infects portable executable files. Because those files have many empty gaps, the virus, which was 1 KB in length, did not add to the size of the file as long as it is placed in a 1 KB gap. Again, if files that may contain these types of viruses are loaded into the buffer 430 as individual files, they may still be discovered by the USB security device 410. The USB security device 410 searches these files loaded into the buffer 430 from the USB device 420 for malware as discussed above similar to how it searches other files within the data buffer 430 for malware.

Some malware may use email attachments as a method to spread to other computers. While virus infected files may be accidentally sent as email attachments, email viruses are aware of email system functions. They generally target a specific type of email system (Microsoft's Outlook is commonly used), harvest email addresses from various sources, and may append copies of themselves to all email sent, or may generate email messages containing copies of themselves as attachments. In some configurations, email attachments may be earlier removed and loaded into the buffer 430 as individual files The USB security device 410 may then search these individual email attachment files for malware as discussed above similar to how it searches other files within the data buffer 430 for malware.

In some configurations, the malware detection logic 440 may also contain cryptographic logic 546 (FIG. 5) to assist in the detection of malware that may decrypt the digital data stored in the memory buffer 440 before the digital data is presented to the malware detection logic 440. For example the cryptographic logic 546 may use a database of file hashes (signatures) for some files stored in the data buffer 430. In some configurations, the malware detection logic 440 includes a hash calculation logic 544 (FIG. 5) that calculates a hash value of files in the data buffer 430 with one or more different hash algorithms and one or more different keys to produce hash results. The malware detection logic 440 may then detect malware in the memory buffer based, at least in part, on the hash values. In one example, when a hash result of a data file matches a hash in the file of known trustworthy/authentic signatures, then the checked file is free of malware, if not, then the checked data file may be infected with malware. These altered files may then be flagged, discarded, or handled in other ways as understood by those of ordinary skill in the art.

Malware may use other methods and techniques to infect data files that may be stored in the data buffer 410. Another technique of evading a data signature detection is to use simple encryption to encipher (encode) the body of the virus, leaving only the encryption module and a static cryptographic key in clear-text which does not change from one infection to the next. In this case, the virus consists of a small plain text decrypting module and an encrypted copy of the virus/malware. If the virus is encrypted with a different key for each infected file, the only part of the virus that remains constant is the plain text decrypting module, which may (for example) be appended to the end of the infected data file. In this case, a virus scanner cannot directly detect the virus using data signatures, but it can still detect the decrypting module, which still makes indirect detection of the virus possible. For example, the malware detection logic 440 may detect the plaintext decryption module by using any of the malware scanning techniques on files stored in the buffer 430 as discussed above to determine if any of those files contained a plaintext decryption module to be used to decrypt one or more encrypted virus/malware modules within the same file.

In other configurations, the USB security buffer 410 (or security device) may have other useful components and features. For example, the USB security buffer 410 may indicate to a user on a graphical user interface (GUI) 560 of the remote host device 412 that malware has been detected and to provide options to the user as to actions to be taken regarding the detected malware. For example, the user may be prompted if the malware should be removed, repair, ignored, or if another action should be taken. In another configuration, the USB security device 410 has a data-bus configured for transferring data between the buffer 430 and the malware detection logic 440.

Methods that can be implemented in accordance with the disclosed subject matter, may be at least partially implemented with reference to the following flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g. device, system, process, component, and so forth). Additionally, it should be further appreciated that in some embodiments the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Thus, various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

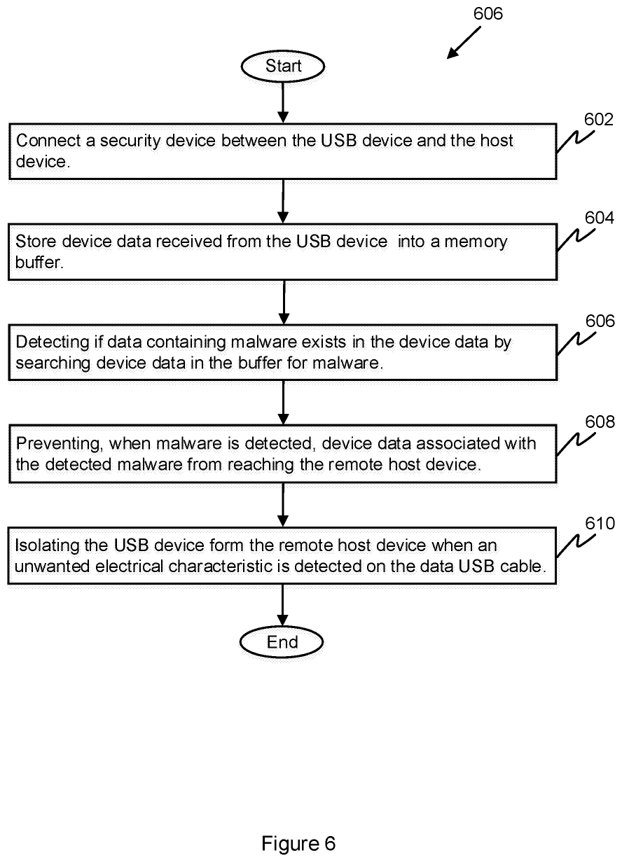

FIG. 6 illustrates some example actions of a method 600 of physically and logically isolating a host device from a USB device. For brevity and the sake of clarity, details discussed earlier are not re-discussed here. The method begins by connecting, at 602, a security device between the USB device and the host device. A USB cable may be used to connect the security device to the host device. Device data received from the USB device is stored into a memory buffer within the security device, at 604. The method detects, at 606, if data containing malware exists in the device data by searching device data in the buffer for malware. For example, a determination may be made that malware is detected when more than a threshold percentage of the device data matches a known malware signature. When malware is detected, the device data associated with the detected malware is prevented from reaching the remote host device, at 608. The method 600 will isolate the USB device form the remote host device, at 610, when an unwanted electrical characteristic is detected on the USB cable. For example the method 600 may optically isolate the security buffer/device from the remote host device when isolating the USB device form the remote host device.

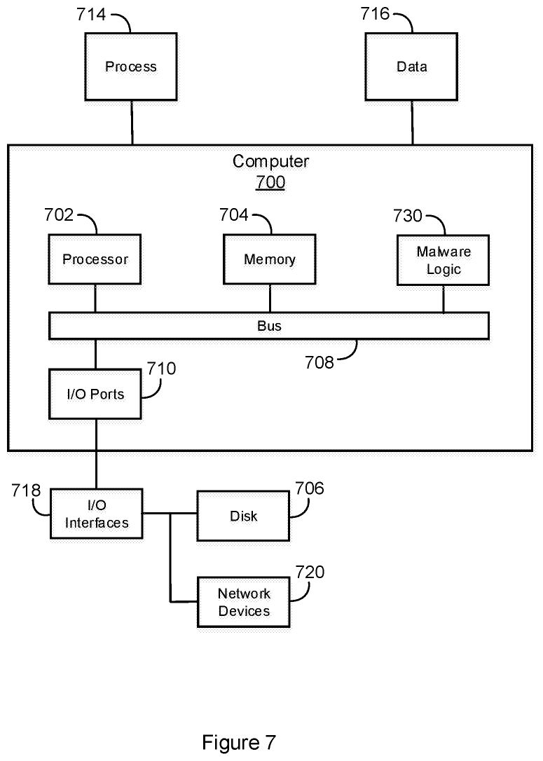

FIG. 7 illustrates an example computing device in which example systems and methods described herein, and equivalents, may operate. The example computing device may be a computer 700 that includes a processor 702, a memory 704, and input/output ports 710 operably connected by a bus 708. In one example, the computer 700 may include a malware logic 730 configured to control various aspects of the security systems 100, 300, 400 and 500 as described above. In different examples, the malware logic 730 may be implemented in hardware, software, firmware, and/or combinations thereof. Thus, the malware logic 730 may provide means (e.g., hardware, software, firmware) for detecting malware in a security buffer/device before the malware reaches a host computer. While the malware logic 730 is illustrated as a hardware component attached to the bus 708, it is to be appreciated that in one example, the malware 730 could be implemented in the processor 702.

Generally describing an example configuration of the computer 700, the processor 702 may be a variety of various processors including dual microprocessor and other multi-processor architectures. The memory 704 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), direct RAM bus RAM (DRRAM) and the like.

A disk 706 may be operably connected to the computer 700 via, for example, an input/output interface (e.g., card, device) 718 and an input/output port 710. The disk 706 may be, for example, a magnetic disk drive, a solid state disk drive, a floppy disk drive, a tape drive, a Zip drive, a flash memory card, and/or a memory stick. Furthermore, the disk 706 may be a CD-ROM, a CD recordable drive (CD-R drive), a CD rewriteable drive (CD-RW drive), and/or a digital video ROM drive (DVD ROM). The memory 704 can store a process 714 and/or a data 716, for example. The disk 706 and/or the memory 704 can store an operating system that controls and allocates resources of the computer 700.

The bus 708 may be a single internal bus interconnect architecture and/or other bus or mesh architectures. While a single bus is illustrated, it is to be appreciated that the computer 700 may communicate with various devices, logics, and peripherals using other busses (e.g., PCIE, SATA, Infiniband, 11384, USB, Ethernet). The bus 708 can be types including, for example, a memory bus, a memory controller, a peripheral bus, an external bus, a crossbar switch, and/or a local bus.

The computer 700 may interact with the input/output devices via the input/output interfaces 718 and the input/output ports 710. The input/output devices may be, for example, a keyboard, a microphone, a pointing and selection device, cameras, video cards, displays, the disk 706, network devices 720, and so on. The input/output ports 710 may include, for example, serial ports, parallel ports, USB ports and the like.

The computer 700 can operate in a network environment and thus may be connected to the network devices 720 via the input/output interfaces 718, and/or the input/output ports 710. Through network devices 720, the computer 700 may interact with a network. Through the network, the computer 700 may be logically connected to remote computers. Networks with which the computer 700 may interact include, but are not limited to, a local area network (LAN), a wide area network (WAN), and other networks. The networks may be wired and/or wireless networks.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims. Accordingly, the disclosure is intended to embrace all such alterations, modifications, and variations that fall within the scope of this application, including the appended claims.

Moreover, the description and illustration of the invention is an example and the invention is not limited to the exact details shown or described. References to “the preferred embodiment”, “an embodiment”, “one example”, “an example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Additionally, references to “the preferred embodiment”, “an embodiment”, “one example”, “an example” and the like, are not to be construed as preferred or advantageous over other embodiments or designs. Rather, use of the words “the preferred embodiment”, “an embodiment”, “one example”, “an example” and the like are intended to present concepts in a concrete fashion.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A security device comprising:
an output connector;
a data cable with a first end and a second end, wherein the first end of the data cable is configured to connect to the output connector and the second end of the data cable is configured to connect to a remote host device, and wherein the remote host device and the security device are physically separated by the data cable;
an input connector for receiving digital data from a peripheral device
a memory buffer to store the digital data in the memory buffer that was received from a peripheral device connected to the input connector; and
a malware detection logic to search the digital data stored in the memory buffer for malware residing in the digital data, wherein the malware detection logic is configured to remove digital data in the memory buffer that is associated with malware residing in the digital data.

2. The security device of claim 1 wherein the malware detection logic further comprises:
a comparison logic configured to compare the digital data stored in the memory buffer with known malware data, wherein the malware detection logic detects malware based, at least in part, on comparisons performed by the comparison logic.

3. The security device of claim 2 wherein the comparison logic is configured to compare at least one of the group consisting of: hexadecimal data and byte size data.

4. The security device of claim 1 wherein the malware detection logic further comprises:
a cryptographic logic configured to decrypt the digital data stored in the memory buffer before the digital data is searched for malware.

5. The security device of claim 1 wherein the malware detection logic further comprises:
a hash calculation logic to calculate a hash value of data in the memory buffer, and wherein the malware detection logic detects malware in the memory buffer based, at least in part, on the hash value.

6. The security device of claim 1 wherein the security device further comprises:
a descriptor table with a list of device descriptors indicating if a device is trusted or non-trusted, wherein the security device is configured to read a descriptor from the peripheral device, and wherein the malware detection logic allows the digital data in the memory buffer to access the remote host device based, at least in part, on the device descriptors in the descriptor table and the descriptor read from the peripheral device.

7. The security device of claim 1 wherein the security device further comprises:
an isolation circuit configured to isolate the remote host device from electrical signals when a voltage on the data cable exceeds a voltage threshold value, and wherein the isolation circuit configured to isolate the remote host device from electrical signals when a current on the data cable exceeds a current threshold value.

8. The security device of claim 7 wherein the isolation circuit further comprise:
optical isolation circuits configured to optically isolate the security device from the remote host device.

9. The security device of claim 1 wherein the security device further comprise:
a housing, wherein the malware detection logic and the memory buffer are contained within the housing, and the data cable is adapted to pass from the housing to the remote host device.

10. The security device of claim 1 wherein the data cable has universal serial bus (USB) connectors at the first end and the second end, and wherein the security cable is at least three feet long.

11. The security device of claim 1 wherein the malware detection logic further comprises:
a malware matching threshold percentage, wherein when more than the malware matching threshold percentage of device data matches a known malware signature within a defined range of memory addresses of the memory buffer, the malware detection logic determines that malware is detected.

12. A USB security device comprising:
a USB cable;
a first USB connector configured to connect to a USB device;
a second USB connector, wherein the USB cable connects between the second USB connector and a remote host device;
a buffer configured to store device data received from the USB device;
a malware detection logic configured to determine data containing malware by searching device data in the buffer for malware, wherein when malware is detected the malware detection logic is configured to prevent device data associated with the detected malware from reaching the remote host device; and
an isolation circuit configured to isolate the USB device form the remote host device when an unwanted electrical characteristic is detected.

13. The USB security device of claim 12 wherein the malware detection logic further comprises:
a malware matching threshold percentage, wherein when more than the malware matching threshold percentage of device data matches a known malware signature within a defined range of memory of the memory buffer, the malware detection logic determines that malware is detected.

14. The USB security device of claim 12 wherein the USB security device further comprises:
a descriptor table indicating descriptors of devices that are trusted and devices that are not trusted, wherein the malware detection logic is configured to determine data containing malware based, at least in part, on if the device data is from a trusted device and if the device data is from a not trusted device.

15. The USB security device of claim 12 wherein the USB cable further comprises:
a first end with a USB connector and a second end with a USB connector.

16. The USB security device of claim 12 wherein the malware detection logic further comprises:
correlation detection logic configured to correlate device data in the buffer to known malware signatures, wherein when malware is detected by correlation, the malware detection logic is configured to prevent device data associated with the detected correlation from reaching the remote host device.

17. The USB security device of claim 12 wherein the USB security device is configured to indicate to user on a graphical user interface (GUI) that malware has been detected and to provide options to the user as to what action is to be taken with the detected malware.

18. The USB security device of claim 12 further comprising:
a data-bus configured to transfer data between the buffer and the malware detection logic.

19. A method of physically and logically isolating a host device from a USB device comprising:
connecting a security device between the USB device and the host device, wherein a USB cable connects the security device to the host device;
storing device data received from the USB device into a memory buffer within the security device;
detecting if data containing malware exists in the device data by searching device data in the buffer for malware;
preventing, when malware is detected, device data associated with the detected malware from reaching the remote host device; and
isolating the USB device form the remote host device when an unwanted electrical characteristic is detected in at least one of the group consisting of: the security device and the USB cable.

20. The method of claim 19 further comprising:
determining that malware is detected when more than a threshold percentage of the device data matches a known malware signature; and
optically isolating the security buffer from the remote host device when isolating the USB device form the remote host device.
